(19) United States
(12) Patent Application Publication
(10) Pub. No.: US 2014/0324590 A1
(43) Pub. Date: Oct. 30, 2014

(54) LOCATION GUIDING TERMINAL AND OPERATING METHOD THEREOF

(71) Applicants: Intellectual Discovery Co., Ltd., Seoul (KR); KR PARTNERS Co., Ltd., Seoul (KR)

(72) Inventors: Hyun Jin KONG, Seongnam-si (KR); Joon Hun KIM, Seoul (KR); Ki Seok NAM, Seoul (KR)

(73) Assignees: Intellectual Discovery Co., Ltd., Seoul (KR); KR PARTNERS Co., Ltd., Seoul (KR)

(21) Appl. No.: 14/263,341

(22) Filed: Apr. 28, 2014

(30) Foreign Application Priority Data
Apr. 26, 2013 (KR) 10-2013-0047025

(51) Int. Cl. H04W 64/00; G06Q 30/02

(52) U.S. Cl. CPC H04W 64/006; G06Q 30/0261
USPC 705/14.58; 455/456.1

(57) ABSTRACT

Provided is a terminal device for providing location guidance, the terminal device including a wireless communication unit configured to detect at least one wireless repeater around the terminal device over a short-range communication, a control unit configured to acquire a vertical location of the terminal device based on identification information of the detected wireless repeater, a display unit configured to display the acquired vertical location, and a sensor unit configured to acquire motion information of the terminal device, in which the control unit outputs variation information regarding the displayed vertical location based on the acquired motion information.

### CROSS-REFERENCE TO RELATED APPLICATIONS

This application claims priority under 35 U.S.C. §119 to Korean Patent Application No. 10-2013-0047025, filed on Apr. 26, 2013, the disclosure of which is incorporated herein by reference in its entirety.

### TECHNICAL FIELD

The present invention relates to a location guiding terminal and an operating method thereof, and more particularly, to a location guiding terminal and an operating method thereof, which can enhance user convenience by providing vertical location guidance.

### BACKGROUND

Recently, smartphones are becoming widespread. In general, smartphones provide a lot of various services using various sensors and a mobile communication. In particular, recently, a large number of location guidance applications using smartphones have been released.

Furthermore, along with such location guidance, advertisements, e.g., product advertisements are provided. This is made by receiving advertisement information or product information from a wireless access point (AP) that is communicable through a WiFi, GPS information, or Bluetooth provided in the terminal device.

However, it is very difficult or impossible to receive GPS signals indoors, and possible only to find out horizontal locations.

Furthermore, in this case, user location information is found based on a wireless AP or repeater in a mobile communication network having multiple cells, but an accuracy of the user location information is approximately 200 to 300 meters, which is too wide to acquire an accurate location.

Also, technologies for tracking a location inside a building through communication with a wireless AP have been proposed, which have limitations in that it is difficult to find an accurate location and if a Zigbee or Bluetooth (10 to 30 meters) device is used to improve the accuracy, many Zigbee or Bluetooth beacons are required to be installed.

Also, even when the location inside the building is found, it is difficult to find a moving route between layers and thus to provide multiple services, for example, a store service etc. on the basis of an accuracy location of a user.

### SUMMARY

Accordingly, the present invention provides a terminal and an operating method thereof that can provide accurate location information and guide movement between floors while using an existing system.

The present invention also provides a method for providing appropriate product information using a network, a terminal device equipped with a sensing function, and a wireless repeater provided in an offline shop.

In one general aspect, a method of operating a terminal for providing location guidance, the method includes: detecting at least one wireless repeater around the terminal over a short-range communication; acquiring a vertical location of the terminal based on identification information of the detected wireless repeater; displaying the acquired vertical location; acquiring motion information of the terminal from at least one sensor; and outputting variation information regarding the displayed vertical location based on the acquired motion information.

In another general aspect, a terminal device for providing location guidance, the terminal device includes: a wireless communication unit configured to detect at least one wireless repeater around the terminal device over a short-range communication; a control unit configured to acquire a vertical location of the terminal based on identification information of the detected wireless repeater; a display unit configured to display the acquired vertical location; and a sensor unit configured to acquire motion information of the terminal device, in which the control unit outputs variation information regarding the displayed vertical location based on the acquired motion information.

Other features and aspects will be apparent from the following detailed description, the drawings, and the claims.

### BRIEF DESCRIPTION OF THE DRAWINGS

FIG. 1 is a block diagram schematically showing a terminal device according to an embodiment of the present invention.

FIG. 2 is a flowchart illustrating an operating method of a terminal device according to an embodiment of the present invention.

FIG. 3 is a flowchart illustrating an operating method of a terminal device according to another embodiment of the present invention.

FIG. 4 is a view illustrating vertical location information varied according to an embodiment of the present invention.

### DETAILED DESCRIPTION OF EMBODIMENTS

The following content merely illustrates the principles of the invention. Therefore, is not clearly described or illustrated herein, although those skilled in the art, but the concept and scope of the present invention and implementation of the principles of the present invention that includes a wide variety of devices that can be invented. In addition, all conditional terms listed herein and understood that the embodiments is intended only for the purpose of, in principle, to understand the concept of the present invention is clearly not limited to the embodiment and state specifically enumerated.

In addition, the principles of perspective and an embodiment of the present invention, as well as to enumerate the specific embodiments is intended to include the structural and functional equivalents of these considerations, a detailed description of all is to be understood. In addition, these waters evenly currently known equivalents as well as equivalents will be developed in the future, i.e., to include all the elements to perform the same function, regardless of structure and invention should be understood.

Thus, for example, a block diagram of the present specification is to be understood to represent a conceptual point of view that embodies the principles of the present invention, an exemplary circuit. Similarly, flow diagrams, state transition, such as pseudo-code, understood to be substantially in a computer readable medium can be represented by a computer or processor has been clearly shown to represent the various processes are performed by a computer or processor, whether or not should be.

The processor or a similar concept that includes the functional blocks shown in the drawings and various features of the device with the ability to run the software in conjunction with the appropriate software may be provided by the use of hardware, as well as dedicated hardware. Features, a single dedicated processor, by the processor when they become available, can be provided by a single shared processor, or a plurality of individual processors, some of which can be shared.

In addition, the use of control processor, or similar terms that are presented as a concept is not to be construed quoted exclusive of hardware, with the ability to run the software, and it should be understood as implicitly including a read-only memory (ROM), a random access memory (RAM), and a nonvolatile memory for storing the digital signal processor (DSP), hardware, and software, without limitation. Also, other well-known hardware may be included. Also, other well-known hardware may be included.

Components are expressed as the means to perform the functions described in the detailed description of the claims herein, including all types of software, for example, which includes a combination of circuit elements that perform the functions or the firmware/microcode intended to include, and how to perform the function of, for performing the functions mentioned above are combined with appropriate circuitry for executing software. Equal the present invention is defined by the scope of these claims, because a combination of the features offered by various means listed and combined with the claim needs to be understood by any means that can provide the functions herein.

The aforementioned objects, features and advantages will become more apparent through the following detailed description with respect to the accompanying drawings, the technical idea of the present invention with a person of ordinary skill in the art the present invention, accordingly, can be easily carried out. In describing the present invention, a detailed description of known techniques associated with the present invention unnecessarily obscure the gist of the present invention, it is determined that the detailed description thereof will be omitted.

Hereinafter, preferred embodiments of the present invention will be described below in more detail with reference to the accompanying drawings.

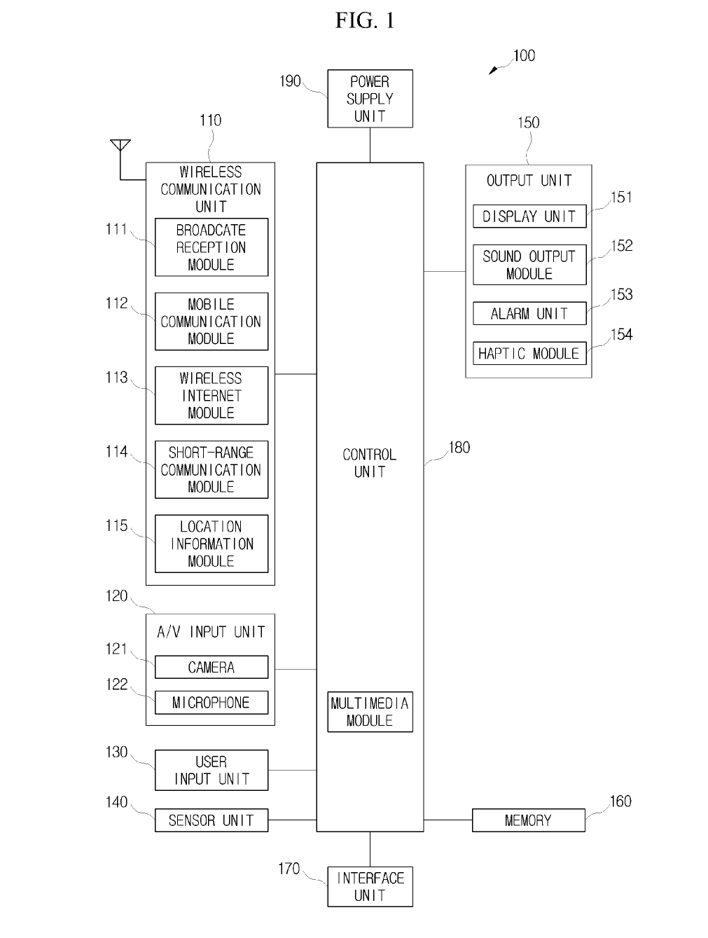

FIG. 1 is a block diagram schematically illustrating a terminal device according to an embodiment of the present invention.

A terminal device 100 according to an embodiment of the present invention may include a mobile phone, a smartphone, a laptop computer, a digital broadcasting terminal, a personal digital assistant (PDA), a portable multimedia player (PMP), and a navigation system. However, it can be understood by a person skilled in the art that configurations according to embodiments described in the specification may be also applied to a fixed terminal such as a digital television and a desktop computer.

Next, a structure of a terminal device according to an embodiment of the present invention will be described with reference to FIG. 1.

FIG. 1 is a block diagram of a terminal device 100 according to an embodiment of the present invention.

The terminal device 100 may include a wireless communication unit 110, an audio/video (A/V) input unit 120, a user input unit 130, a sensor unit 140, an output unit 150, a storage unit 160, an interface unit 170, a control unit 180, and a power supply unit 190. The elements shown in FIG. 1 are not essential, such that the terminal device may be implemented to have more or less elements.

The wireless communication unit 110 may include one or more modules capable of wireless communication between the terminal device 100 and a wireless communication system or between the terminal device 100 and a network in which the terminal device 100 is located. For example, the wireless communication unit 110 may include a broadcast reception module 111, a mobile communication module 112, a wireless Internet module 113, a short-range communication module 114, and a location information module 115.

The broadcasting reception module 111 receives a broadcasting signal and/or broadcasting-related information from an external broadcasting management server through a broadcasting channel.

The broadcasting signal and/or broadcasting-related information received by the broadcasting reception module 111 may be stored in the storage unit 160.

The mobile communication module 112 may communicate a wireless signal with at least one of a base station, an external terminal, and a server over a mobile communication network. The wireless signal may include a voice call signal, a video call signal, or any other forms of data depending on transmission or reception of a text or multimedia message.

The wireless internet module 113 is a module for accessing wireless Internet, which may be built in or out of the terminal device 100. Examples of the wireless Internet technology may include wireless LNA (WLA) (for example, Wi-Fi), Wireless Broadband (Wibro), World Interoperability for Microwave Access (Wimax), and High Speed Downlink Packet Access (HSDPA).

The short-range communication module 114 is a module for short range communication. Examples of the short-range communication technology may include Bluetooth, Radio Frequency Identification (RFID), Infrared Data Association (IrDA), Ultra Wideband (UWB), Zigbee, and so on.

The location information module 115 is a module for acquiring a location of a terminal device, a representative example of which is a Global Positioning System (GPS) module.

Referring to FIG. 1, the audio/video (A/V) input unit 120 is a unit for inputting an audio signal or video signal, which may include a camera 121 and a microphone 122. The camera processes an image frame such as a still image or a video, which is obtained by an image sensor in a video call mode or a photographing mode. The processed image frame may be displayed on a display unit 151.

The image frame processed by the camera 121 may be stored in the storage unit 160 or transmitted to the outside through the wireless communication unit 110. The camera 121 may be plural in number depending on the usage environment.

The microphone 122 receives a sound signal from the outside in a call mode, a recording mode, or a voice recognition mode and processes the received sound signal into electrical voice data.

The user input unit 130 generates input data used for a user to control an operation of a terminal. The user input unit 130 may be configured with a key pad, a dome switch, a touch pad (capacitive type/pressure type), a jog wheel, a jog switch, and so on.

Authentication information may be input through the user input unit 130, and input pattern data may be generated during a process for inputting the authentication information.

The sensor unit 140 senses a current state of the terminal device 100, such as an opened/closed state of the terminal device 100, a location of the terminal device 100, presence of user contact, an orientation of the terminal device 100, and acceleration and deceleration of the terminal device 100 to generate a sensing signal for controlling an operation of the terminal device 100. For example, when the terminal device 100 is a slide phone, the sensor unit 140 may sense whether the slide phone is opened or closed. Furthermore, the sensor unit 140 may sense whether the power supply unit 190 supplies power or whether the interface unit 170 connects to an external equipment. Also, the sensor unit 140 may include a proximity sensor 141.

In addition, the sensor unit 140 may include, for example, an altitude sensor, an acceleration sensor, a gyro sensor, an atmospheric sensor, etc.

The output unit 150 is intended to generate an output related to visual, auditory, and tactile senses, and may include a display unit 151, a sound output module 152, an alarm unit 153, and a haptic module 154.

The display unit 151 displays (outputs) information processed by the terminal device 100. For example, when the terminal device is in a call mode, the display unit 151 displays a user interface (UI) or graphic user interface (GUI), which is associated with the call. When the call device 100 is in a video call mode or a photographing mode, the display unit 151 displays a photographed and/or received image, an UI, and a GUI.

The display unit 151 may include at least one of a liquid crystal display (LCD), a thin film transistor-liquid crystal display (TFT LCD), an organic light-emitting diode (OLED), a flexible display, and a three-dimensional (3D) display.

When the display unit 151 and a sensor for sensing a touch operation (hereinafter referred to as a “touch sensor”) constitute a mutual layered structure (hereinafter referred to as a “touch screen”), the display unit 151 may be used as an input device in addition to an output device. Examples of the touch sensor may include a touch film, a touch sheet, a touch pad, and so on.

The touch sensor may be configured to convert change in pressure applied to a specific portion of the display unit 151 or change in capacity generated in a specific portion of the display unit 151 into an electrical input signal. The touch sensor may be configured to detect touch pressure in addition to a touch position or area.

When a touch input is made on the touch sensor, a signal corresponding to the touch input is transmitted to a touch controller. The touch controller processes the signal and then transmits data corresponding to the processed signal to the control unit 180. Thus the control unit 180 may determine which area of the display unit 151 is touched.

The sound output module 152 may output audio data received from the wireless communication unit 110 in a call signal reception mode, a communication mode, a recording mode, a voice recognition mode, and a broadcasting reception mode or stored in the storage unit 160. The sound output module 152 may output a sound signal related to a function (for example, call signal reception sound, message reception sound, etc.) which is performed by the terminal device 100. The sound output module 152 may include a receiver, a speaker, a buzzer, and so on.

The alarm unit 153 outputs a signal for alarming occurrence of an event in the terminal device 100. Examples of events occurred in the terminal device may include a call signal reception, a message reception, a key signal input, and a touch input. The alarm unit 153 may output another form of signal other than a video or audio signal, for example, a signal for alarming occurrence of an event using vibration. The video or audio signal may be output through the display unit 151 or the voice output module 152. Thus the display unit 151 and the voice output module 152 may be considered as a portion of the alarm unit 153.

The haptic module 154 generates various haptic effects that a user may feel. A representative example of the haptic effects generated by the haptic module 154 is vibration. The strength and pattern of the vibration generated by the haptic module 154 are controllable. For example, different vibrations may be output synthetically and sequentially.

The storage unit 160 may store a program for operating the control unit 180, and may temporarily store input/output data (for example, a phonebook, a message, a still image, and a video). The storage unit 160 may store data regarding various patterns of vibration and sound that are output when a touch input is made on the touch screen.

The storage unit 160 include at least one type of storage medium including a flash memory, a hard disk, a multimedia micro card, a card memory (e.g., SD or DX), a random access memory (RAM), static random access memory (SRAM), a read-only memory (ROM), an electrically erasable programmable read-only memory (EEPROM), a programmable read-only memory (PROM), a magnetic memory, a magnetic disk, or an optical disk. The terminal device 100 may cooperate with a web storage device that performs the storage function of the storage unit 160 over the Internet.

The interface unit 170 may function as a communication channel to an external device connected to the terminal device 100. The interface unit 170 is configured to receive data or power from the external device to transmit the received data or power to each element in the mobile terminal 100 or receive data from the terminal device 100 to transmit the data to the external device. For example, the interface unit 170 may include a wired/wireless headset port, an external charger port, a wired/wireless data port, a memory card port, a portion connecting to a device having an identification module, an audio input/output (I/O) port, a video I/O port, or an earphone port.

The identification module is a chip for storing various information used to authenticate a usage authority of the terminal device 100, which may include a user identity module (UIM), a subscriber identity module (SIM), or a universal subscriber identity module (USIM). The device having such an identification module (hereinafter referred to as an “identification unit”) may be configured as a smart card. Accordingly, the identification unit may be connected with the terminal device 100 via a port.

When the terminal device 100 is connected with an external cradle, the interface unit 170 may serve as a passage for supplying power from the cradle to the terminal device 100 or a passage for delivering various command signals input from the cradle by the user to the terminal device 100. The various command signals or power input or supplied from the cradle may operate as signals for indicating that the terminal device 100 has been exactly mounted on the cradle.

The controller 180 typically controls overall operations of the terminal device. For example, the controller 180 performs relevant control and processing associated with a voice call, a data communication, and a video call. In addition, the controller 180 may include a multimedia module 181 for reproducing (or playing back) multimedia data. The multimedia module 181 may be configured within the controller 180 or configured independently of the controller 180.

The controller 180 may perform pattern recognition processing to recognize a handwriting input or a picture drawing input made on the touch screen as characters or images. The control unit 180 may generate input pattern data through the pattern recognition processing.

The power supply unit 190 receives external power or internal power to supply appropriate power required to operate respective elements under the control of the controller 180.

Specifically, the control unit 180 acquires a vertical location of the terminal on the basis of identification information of the detected repeater and output variation information about the displayed vertical location on the basis of a motion sensed by the sensor unit 140.

For example, the vertical location may correspond to a specific floor inside a building where the terminal device 100 is located, and the variation information may include inter-floor movement information.

The control unit 180 may perform control that first shop information received from the wireless repeater through the wireless communication unit 110 may be displayed.

In addition, the control unit 180 may determine a floor to which the terminal device 100 is moved based on the vertical location and variation information and control the display unit to display second shop information corresponding to the determined floor.

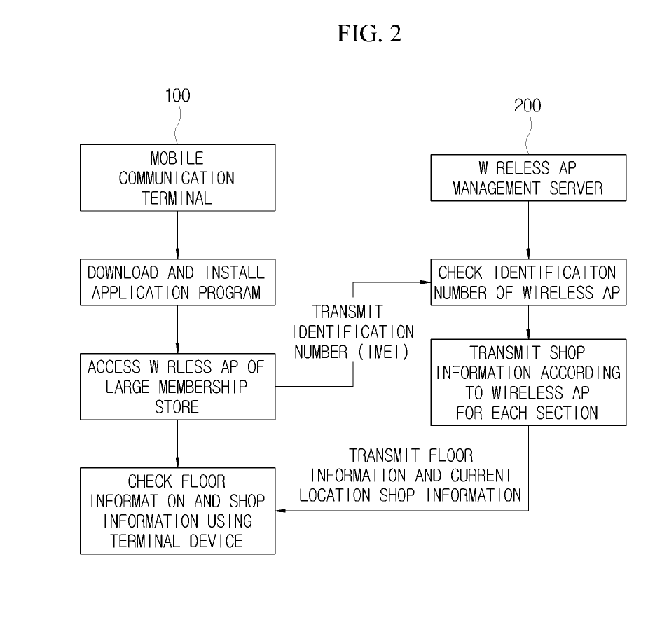

FIG. 2 is a flowchart illustrating an operating method of a terminal device 100 according to an embodiment of the present invention.

The terminal device 100 according to an embodiment of the present invention may be a terminal, which may include a sensor, such as RF communication, WiFi, Bluetooth, a barometer, GPS support, and an accelerometer.

The wireless AP may communicate data, such as product information, on the basis of the location information measured from the terminal device.

A wireless AP management server 200 may process data received from the wireless AP and provide the product information.

First, the terminal device (or terminal) 100 downloads and installs an application for location guidance.

Then, when the terminal device 100 enters a shop of a large membership store, the wireless communication unit 110 accesses a wireless AP located around it.

Subsequently, the control unit 180 may check and output floor information and shop information corresponding to the floor through communication with the accessed wireless AP.

In this case, identification information of the accessed wireless AP may be transmitted to the wireless AP management server 200 of the membership store.

The wireless AP management server 200 may determine a section where the wireless AP is located, on the basis of the identification information of the wireless AP, and transmit floor information and shop information to the terminal device 100 depending on the section.

For example, the terminal device may install an application provided by the large membership store, such as a department store and a supermarket, to receive floor shop information, location information, discount information including coupons, stamp service for managing client visit histories, and point service. The application provided by the large membership store may extract data measured in the above-described sensor information from the terminal device to transmit the data to a wireless AP installed in each floor. This wireless AP may be managed by the wireless AP management server 200 and installed to be extracted using a triangulation technique. Thus the wireless AP serves to primary inform the terminal device 100 of location information of the shop in a floor base of the large membership store.

As such, the location information or shop information may be exchanged between the terminal device 100 and the wireless AP management server 200, thus allowing a location-based product information providing service to be provided.

As described above, a typical method for locating a terminal device mainly using GPS has difficulties in measuring an accurate location indoors and locates and is only used in a two-dimensional area. The GPS information is mainly used for outdoor measurement, and even a cellular signal having a short propagation distance has difficulties in passing through several thick obstacles such as a concrete building.

Thus embodiments of the present invention may propose a method for extracting various sensor information of a terminal device using an application program, and on the basis of a wireless AP installed in a building of a large membership store, checking whether the terminal device enters an area of the wireless AP, tracking the terminal device, and proving location-based product information according to an area in a proceeding direction.

That is, according to an embodiment of the present invention, a solution for accurately measuring an indoor location using various sensors without a recent standard such as Bluetooth may be provided.

A user may install an application program provided by a large membership store such as a department store and a supermarket in his/her terminal device. The application program may be executed by the user, or configured to reside in a memory as a background service and executed when the terminal device 100 senses entry into the building through a wireless AP signal.

The control unit 180 of the terminal device 100 having an application program installed therein may control the wireless communication unit 110 and distinguish a serial number, for example, an identification number (e.g., international mobile equipment identity (IMEMI)). The sectional wireless AP may be identified by its identification number, and the identification number may be transmitted over a network such as TCP/IP. The wireless AP management server 200 may manage the serial number of the wireless AP on a sectional basis, and control unit 180 may receive shop information corresponding to the section where the terminal device 100 is located, through the wireless AP management server 200, and output the shop information.

The AP management server 200 may process data received from the wireless AP to generate the shop information corresponding to the location. In addition, the wireless AP management server may manage a location of the wireless AP, a status of a network, and failure or not on an area or floor basis, manage shop information on a sectional basis, and provide the shop information to the terminal device 100.

When the terminal device 100 of the user is moved to another floor, or another section in the same floor, the identification number of the terminal device 100 may be transmitted to the wireless AP. The identification number of the terminal device 100 may be transmitted to the wireless AP management server 200, utilized as access information of the user, and used to transmit a separate push message for each user.

For example, the wireless AP management server 200 may acquire the location information received from the terminal device 100 and section information of the wireless AP and transmit shop information corresponding thereto to the terminal device 100. When the shop information is required to be changed because of floor change, the wireless AP management server 200 may transmit a push message including change information according to the identification number of the terminal device.

The user may be served with several services, such as discount information, product information, product history, point information, and a coupon, provided in a floor where the user is located according to an embodiment of the present invention.

A triangulation technique for measuring a location using strengths of radio waves of three APs is basically used as a measurement technique of a wireless AP installed for each floor in order to accurately measure information about the terminal device. For a wireless fidelity (WiFi) signal, a propagation distance is generally 30 to 40 meters, and may be 100 meters or more without obstacles. In consideration of this in a sectional basis, the wireless AP is required to be installed, and wireless AP sections are required to be managed using a database (DB) list by the wireless AP management server.

However, this allows just primary data, inter-floor movement is difficult to detect, there is a region where calculation between locations of the wireless APs is impossible, and accurate measurement is limited. Accordingly, an indoor location should be measured using various sensors in order to accurately inform user location and shop information to a map of a corresponding floor.

Accordingly, the sensor unit 140 of the terminal device 100 may include various sensors, such as a gyroscope, an earth magnetic field sensor, an accelerometer, and an altimeter. Information measured using the sensors may be used for the control unit 180 to perform location determination according to a first embodiment of the present invention and transmitted to the wireless AP.

According to a second embodiment of the present invention, if the terminal device 100 enters a coverage of the wireless AP, location information of the terminal device 100 may be primarily transmitted to the wireless AP management server 200. Then, according to an approximate location of the terminal device 100, the wireless AP management server 200 may transmit a floor shop map stored therein to the terminal device 100.

In addition, the terminal device 100 may measure detailed user location information using the accelerometer. The control unit 180 may determine the number of walks using the accelerometer, calculate a movement distance through a required time according to the number of walks, and display the calculated movement distance on a map.

When the terminal device 100 is moved, the movement distance calculated through the accelerometer is transmitted to the wireless AP. The wireless AP management server 200 may calculate location information according to the transmitted movement distance.

The control unit 180 may move a current location on the map by the movement distance and display shop names around the current location and a corresponding floor on a screen. Since the acceleration indicates only increase or decrease in speed of a straight-line motion in a specified direction, the control unit 180 may determine an angular velocity, that is, a direction through the gyroscope. As such, accurate measurement may be made by distinguishing a velocity and an angle through the direction of the terminal device based on one axis.

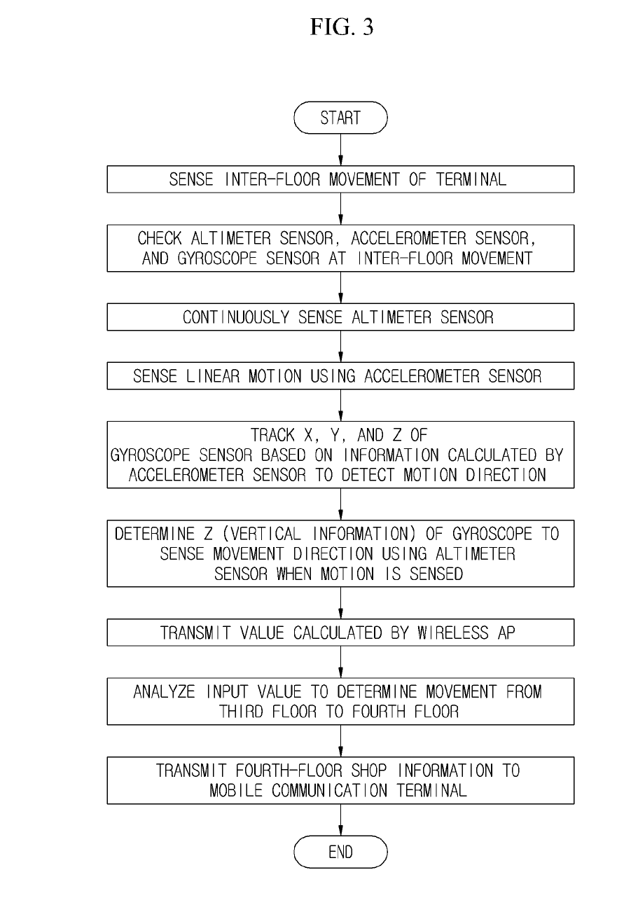

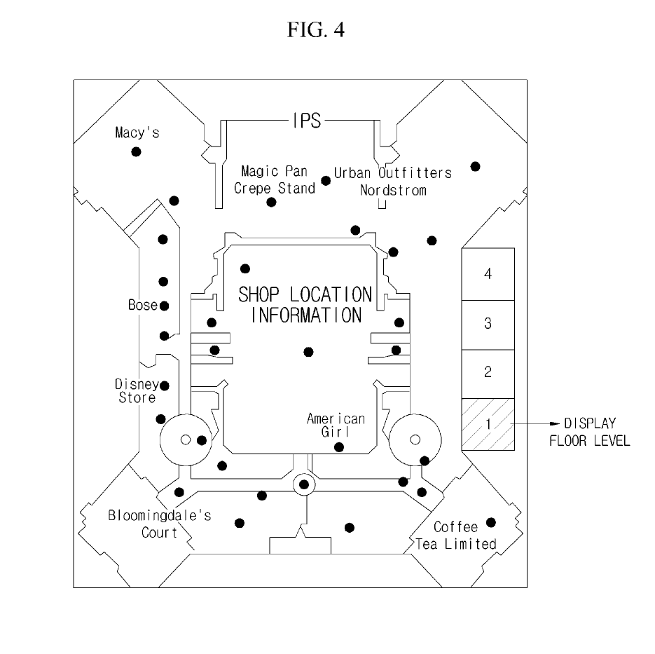

FIG. 3 is a flowchart illustrating an operating method of a terminal device according to another embodiment of the present invention, and FIG. 4 is a view illustrating vertical location information displayed on the terminal device according to an embodiment of the present invention.

As illustrated in FIG. 3, the terminal device 100 according an embodiment of the present invention may sense an inter-floor movement in addition to a direction and an angle.

Specifically, the terminal device 100 according to an embodiment of the present invention allows an inter-floor navigation. In general, a floor where the AP is installed may be found through the sectional wireless AP. However, when an inter-floor height is 4 meters or less, and it is difficult to accurately find a middle location between floors during inter-floor movement.

However, according to an embodiment of the present invention, it is possible to calculate an altitude or floor level according to a height of a building using the data sensed during inter-floor movement by stairs, escalators, and elevators, thereby accurately distinguishing the floor.

For example, if the terminal device 100 enters an ambiguous area between the third floor and the fourth floor, the terminal device 100 may calculate its own location using a triangulation technique based on angles of wireless APs, measure a motion direction using at least one of an altimeter, an accelerometer, and a gyroscope, determine the movement direction, and display floor information changed according to the movement direction.

The terminal device 100 may monitor a value of a sensor, which is varied during inter-floor movement. The terminal device 100 may detect only a linear direction during inter-shop movement to perform location guidance. For example, the terminal device 100 may determine that the movement is made in the same direction when there is no displacement in z-axis direction among the x-axis (rotational axis), y-axis (horizontal axis), and z-axis (vertical axis) and also the height sensed by the altimeter is constant, such that terminal device 100 may provide inter-shop movement guidance.

However, when a straight-line motion is a fixed or constant value and a vertical movement is detected by a gyroscope sensor, for example, when the user takes an elevator or escalator, the terminal device 100 may determine that the movement is an up-and-down motion.

In a case in which the user is on the third floor, the terminal device 100 may check information of the altimeter in order to determine that movement is made to the fourth floor. When it is determined that the movement is made to the fourth floor, the terminal device 100 may receive information about the fourth floor through the wireless AP and display the information.

Accordingly, the terminal device 100 may acquire location information according to a characteristic of each sensor, and sense the inter-floor movement by sensing the gravity, sensing change in location by altimeter, or sensing change in area of the accessed wireless AP.

As such, according to an embodiment of the present invention, it is possible to solve problems where it is difficult to determine an indoor location using GPS and manage a number of beacons, which are installed in order to accurately measure the location through Bluetooth or Zigbee, by using the triangulation technique of the wireless APs and the various sensors of the terminal device.

In addition, it is possible to inform more detailed shop information and transmit, at the elevator, information about a corresponding floor through a push message of the terminal during inter-floor movement, thereby facilitating product purchase and shopping in the floor.

Furthermore, embodiments of the present invention may cooperate with a coupon service or a shop search service. For a discount event in a specific shop of a membership store, a discount coupon may be transmitted to the terminal through a push message, the terminal device 100 may display the transmitted discount coupon when it is determined that a user passes in front of a shop that has issued the discount coupon, and the user may purchase a product using a price with the discount coupon and product information.

Since the terminal device 100 according to an embodiment of the present invention allows location-based geo-fencing, it is also possible to designate a specific usage section to make sectional payment.

For example, in a case in which payment is made through a mobile wallet, embodiments of the present invention may cooperate with a service for automatically performing notification through a push message when a mobile phone is lost or a child, of which location is precisely tracked, enters a store that is not approved by his/her parent.

Also, the method according to an embodiment may be implemented by a program to be executed in a computer and then stored in a computer readable recording medium. Examples of the computer readable recording medium include read-only memory (ROM), random-access memory (RAM), CD-ROMs, magnetic tapes, floppy disks, optical data storage devices, and carrier waves (such as data transmission through the Internet).

The computer readable recording medium can also be distributed over network coupled computer systems so that the computer readable code is stored and executed in a distributed fashion. Also, functional programs, codes, and code segments for realizing the method can be easily construed by programmers skilled in the art to which the present invention pertains.

According to an embodiment of the present invention, it is possible to perform accurate location guidance with an existing system, and notify in advance a user of information about a shop, where the user intends to go, in consideration of variation information about a vertical location.

It is also possible to provide appropriate product information based on a floor and a shop, by communicating with a wireless repeater of the shop through a wireless communication unit on the basis of sensor information of the terminal device.

While this invention has been particularly shown and described with reference to preferred embodiments thereof, it will be understood by those skilled in the art that various changes in form and details may be made therein without departing from the spirit and scope of the invention as defined by the appended claims, and also the various changes should not be understood departing from the spirit and scope of the invention.

What is claimed is:

1. A method of operating a terminal for providing location guidance, the method comprising:
detecting at least one wireless repeater around the terminal over a short-range communication;
acquiring a vertical location of the terminal based on identification information of the detected wireless repeater;
displaying the acquired vertical location;
acquiring motion information of the terminal from at least one sensor; and
outputting variation information regarding the displayed vertical location based on the acquired motion information.

2. The method of claim 1, wherein the vertical location corresponds to a specific floor inside a building where the terminal is located.

3. The method of claim 1, wherein the variation information includes inter-floor movement information of the terminal.

4. The method of claim 1, further comprising:
receiving first shop information corresponding to the vertical location from the wireless repeater; and
displaying the received first shop information.

5. The method of claim 1, further comprising:
determining a floor to which the terminal is moved based on the vertical location and the variation information; and
displaying second shop information corresponding to the determined floor.

6. A terminal device for providing location guidance, the terminal device comprising:
a wireless communication unit configured to detect at least one wireless repeater around the terminal device over a short-range communication;
a control unit configured to acquire a vertical location of the terminal device based on identification information of the detected wireless repeater;
a display unit configured to display the acquired vertical location; and
a sensor unit configured to acquire motion information of the terminal device,
wherein the control unit outputs variation information regarding the displayed vertical location based on the acquired motion information.

7. The terminal device of claim 6, wherein the vertical location corresponds to a specific floor inside a building where the terminal is located.

8. The terminal device of claim 6, wherein the variation information includes inter-floor movement information of the terminal.

9. The terminal device of claim 6, wherein,
the wireless communication unit receives first shop information corresponding to the vertical location from the wireless repeater, and
the display unit displays the received first shop information.

10. The terminal device of claim 6, wherein the control unit determines a floor to which the terminal is moved based on the vertical location and the variation information; and controls a display unit to display second shop information corresponding to the determined floor.
